(19) United States
(12) Patent Application Publication
(10) Pub. No.: US 2015/0272166 A1
(43) Pub. Date: Oct. 1, 2015

(54) GELATIN-BASED FISH FOOD PRODUCT

(71) Applicant: SAN FRANCISCO BAY BRAND, INC., Newark, CA (US)

(72) Inventors: Andreas Schmidt, Newark, CA (US); Yana Dutt-Singkh, Newark, CA (US)

(21) Appl. No.: 14/432,126

(22) PCT Filed: Sep. 30, 2013
(86) PCT No.: PCT/US13/62706

§ 371 Date: Mar. 27, 2015

Related U.S. Application Data
(60) Provisional application No. 61/708,192, filed on Oct. 1, 2012.

(51) Int. Cl. A23K 1/18; A23K 1/10

(52) U.S. Cl. CPC A23K 1/188; A23K 1/103

(57) ABSTRACT

In one embodiment, a product for feeding aquatic life includes a colloid-based binding agent and a fish food matter suspended in the binding agent. In a further embodiment, a product for feeding aquatic life includes a fish gelatin derived from collagen of at least one species of fish, wherein the fish gelatin is dissolvable in water and a fish food matter suspended in the fish gelatin. The fish food product is dissolvable in water. As the fish food product dissolves, it releases fish food into the water. The fish food may include food sources that are appropriate for feeding a plurality of different types of aquatic life.

### CROSS REFERENCE TO RELATED APPLICATIONS

This application claims the benefit of International Application No. PCT/US2013/062706, filed Sep. 30, 2013, which claims the benefit of U.S. Provisional Patent Application Ser. No. 61/708,192, filed Oct. 1, 2012, all of which are herein incorporated by reference in its entirety.

### FIELD OF THE INVENTION

The present invention generally relates to the field of fish food, and more specifically relates to fish food products that are appropriate for feeding a variety of aquatic life residing in a single aquatic environment.

### BACKGROUND

Aquatic environments such as aquariums and ponds may include a variety of aquatic life, including various species of fish, reptiles, amphibians, and/or aquatic and semi-aquatic mammals. This is especially true of public aquariums, which often house a plurality of species ranging from very small to very large species in a single large tank. Generally, each of these types of aquatic life has different nutritional needs and requires different food sources. Moreover, the different types of aquatic life may reside in different sections of the aquatic environment (e.g., some may reside near the surface of the water, while others are bottom dwellers). As such, various types of food must be kept on hand to maintain the environment and meet the nutritional needs of all of the aquatic life residing in it.

### SUMMARY OF THE INVENTION

In one embodiment, a product for feeding aquatic life includes a colloid-based binding agent and a fish food matter suspended in the binding agent.

In a further embodiment, a product for feeding aquatic life includes a fish gelatin derived from collagen of at least one species of fish, wherein the fish gelatin is dissolvable in water and a fish food matter suspended in the fish gelatin.

The fish food product is dissolvable in water. As the fish food product dissolves, it releases fish food into the water. The fish food may include food sources that are appropriate for feeding a plurality of different types of aquatic life.

### BRIEF DESCRIPTION OF THE DRAWINGS

The teachings of the present invention can be readily understood by considering the following detailed description in conjunction with the accompanying drawings, in which:

FIGS. 1A-1B illustrate one embodiment of a fish food product, according to the present invention; and

FIG. 2 illustrates one example of a conventional gelatin-based product.

### DETAILED DESCRIPTION

In one embodiment, the present invention is a gelatin- or colloid-based fish food product that is dissolvable in water. As the fish food product dissolves, it releases fish food into the water. The fish food may include food sources that are appropriate for feeding a plurality of different types of aquatic life, such that only a single fish food product needs to be dispensed into the aquatic environment.

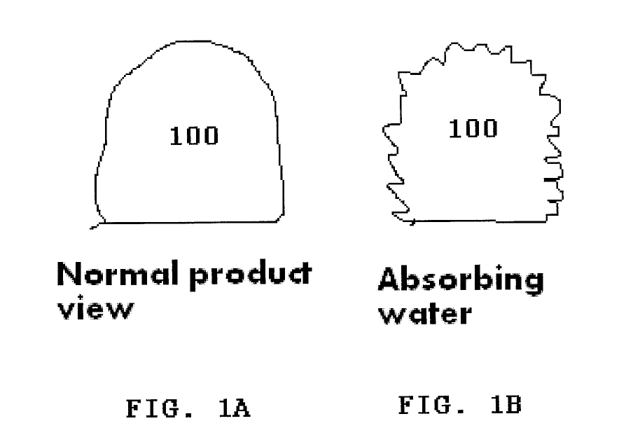

FIGS. 1A-1B illustrate one embodiment of a fish food product 100, according to the present invention. In particular, FIG. 1A illustrates the fish food product 100 in its dry form (i.e., before it is dispensed into an aquatic environment), while FIG. 1B illustrates the fish food product 100 as it absorbs water (i.e., after it is dispensed into an aquatic environment).

As illustrated in FIG. 1A, the fish food product 100 has a soft, spongy, generally marshmallow-like structure. The fish food product 100 comprises fish food matter (e.g., fresh, frozen, and/or freeze-dried brine shrimp, micro-algae, krill, plankton, bloodworms, seaweed, etc.) suspended in a colloid- or gelatin-based binding agent. In one embodiment, the fish food matter comprises a plurality of different types of fish food matter, designed for feeding a plurality of different species of aquatic life having different nutritional needs. In this case, all of the fish food matter is generally selected to be suitable either for freshwater aquatic life or for saltwater aquatic life. However, in other embodiments, the fish food matter may comprise fish food matter designed for feeding only a single species of aquatic life.

In one embodiment, the binding agent is a hydrocolloid such as a fish gelatin (i.e., a gelatin derived from the collagen of a fish, such as a tilapia, carp, cod, Pollock, haddock, salmon, or catfish). In a further embodiment, the fish gelatin is a cold-processed gelling system. Fish gelatin is a unique hydrocolloid and includes a lower content of two particular amino acids—proline and hydroxyproline—than mammalian gelatins. The concentrations of these amino acids in the fish gelatin affect the gelatin's molecular weight, ionic strength, pH, cooling rate, and method of application.

As illustrated in FIG. 1B, when the fish food product is placed in water, the fish food product 100 absorbs the water. As the water is absorbed, the fish food product 100 generally holds its shape while it gradually dissolves and dispenses the fish food matter into the water for consumption by the aquatic life. In one embodiment, the ability of the fish food product 100 to gradually release the fish food matter while holding its shape is a result of the gel strength of the binding agent (which is a function of the concentrations of proline and hydroxyproline in the gelatin). In one embodiment, the gel strength is strong enough to float the fish food product 100 in the water without collapsing, but is not so strong that the fish food matter is inaccessible to the aquatic life. For instance, the fish food matter should be easily released into the water and should also be able to be easily disintegrated by the aquatic life (e.g., without undue expenditure of energy).

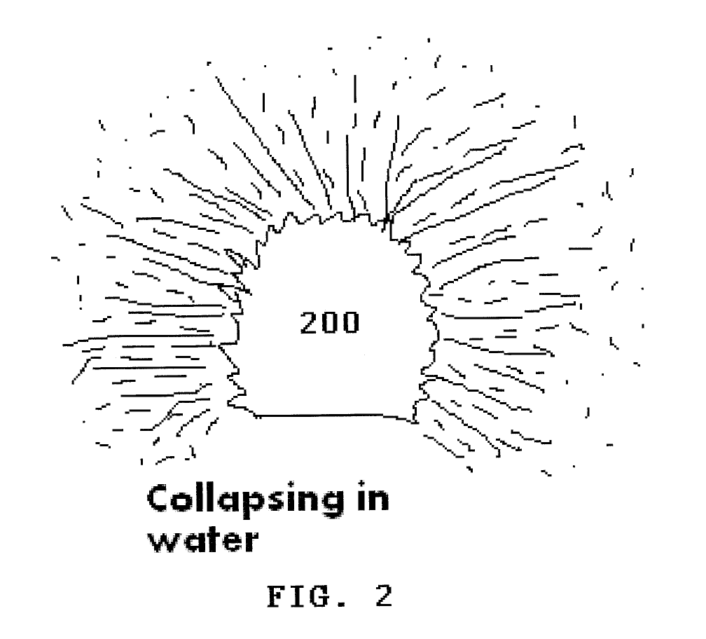

This stands in contrast to conventional gelatin-based products, which tend to quickly collapse in water. FIG. 2, for instance, illustrates an example of conventional gelatin-based product 200 that has been placed in water. As illustrated, the conventional gelatin-based product 200 has collapsed. Thus, the conventional gelatin-based product 200 would not be ideal for use in aquatic environments, since it upon collapsing it would release its contents quickly into the water. The contents would then cloud the water, which is undesirable.

The fish food product 100 therefore provides a single solution that is suitable for feeding a plurality of different types of aquatic life (e.g., various species of fish, reptiles, amphibians, and/or aquatic and semi-aquatic mammals). The fish food product 100 is substantially free from preservatives and other ingredients that are not natural parts of an aquatic diet (e.g., because a fish gelatin binding agent is used rather than a gelatin obtained from another species of animal). The fish food product 100 is especially suitable for frozen fish food applications.

Moreover, manufacturing of the fish food product 100 is simplified when fish gelatin is used as the binding agent, since the fish gelatin does not need to be heated to a high temperature during the manufacturing. In particular, although the fish gelatin does need to be melted during manufacturing, it does not need to be heated to a high temperature, because, at certain concentrations of proline and hydroxyproline, the fish gelatin has relatively low melting and gelling temperatures. The precise melting and gelling temperatures (or ranges of temperatures) depend on various factors including the species of fish from which the gelatin is derived and the pH of the gelatin. Generally, fish gelatin becomes soluble when its helical structure unfolds (which is dependent on the concentrations of proline and hydroxyproline). Thus, the melting temperature is proportional to the concentrations of proline and hydroxyproline in the gelatin. A fish gelatin solution will typically remain in liquid phase at room temperature. The gelling temperature of a fish gelatin generally ranges from approximately zero to ten degrees Celsius and sometimes ranges up to approximately room temperature. For instance, gelatin derived from tilapia gels at temperatures in the range of approximately zero to five degrees Celsius and re-gels at a temperature of approximately fifteen degrees Celsius.

A further benefit of this low-temperature manufacturing process is that a majority of the vitamins, oils, and fatty acids of the fish food matter can be preserved without degradation. Moreover, the flavor of the frozen fish food matter that is suspended in the gelatin is preserved through the low-temperature processing, making the fish food product more attractive to the aquatic life.

Although various embodiments which incorporate the teachings of the present invention have been shown and described in detail herein, those skilled in the art can readily devise many other varied embodiments that still incorporate these teachings.

What is claimed is:

1. A product for feeding aquatic life, the product comprising:
a colloid-based binding agent; and
a fish food matter suspended in the binding agent.

2. The product of claim 1, wherein the binding agent is a hydrocolloid.

3. The product of claim 1, wherein the hydrocolloid is a gelatin.

4. The product of claim 3, wherein the gelatin is a fish gelatin.

5. The product of claim 4, wherein the fish gelatin is derived from fish collagen.

6. The product of claim 5, wherein the fish collagen comprises tilapia collagen.

7. The product of claim 5, wherein the fish collagen comprises carp collagen.

8. The product of claim 5, wherein the fish collagen comprises cod collagen.

9. The product of claim 5, wherein the fish collagen comprises pollock collagen.

10. The product of claim 5, wherein the fish collagen comprises haddock collagen.

11. The product of claim 5, wherein the fish collagen comprises salmon collagen.

12. The product of claim 5, wherein the fish collagen comprises catfish collagen.

13. The product of claim 4, wherein the fish gelatin is cold processed.

14. The product of claim 1, wherein the fish food matter comprises fish food matter designed to meet nutritional needs of a single species of aquatic life.

15. The product of claim 1, wherein the fish food matter comprises fish food matter designed to meet nutritional needs of a plurality of species of aquatic life.

16. The product of claim 15, wherein the plurality of species comprises a plurality of saltwater aquatic species.

17. The product of claim 15, wherein the plurality of species comprises a plurality of freshwater aquatic species.

18. The product of claim 1, wherein the product has a generally spongy structure.

19. The product of claim 1, wherein the binding agent is dissolvable in water.

20. A product for feeding aquatic life, the product comprising:
a fish gelatin derived from collagen of at least one species of fish, wherein the fish gelatin is dissolvable in water; and
a fish food matter suspended in the fish gelatin.
